(19) United States
(12) Patent Application Publication
(10) Pub. No.: US 2024/0142624 A1
(43) Pub. Date: May 2, 2024

(54) PERFORMANCE OF DOUBLE SIDEBAND SUPPRESSED CARRIER (DSB-SC) MODULATION

(71) Applicant: AQRONOS, INC., Broomfield, CO (US)

(72) Inventor: Hao LIU, Nanjing (CN)

(21) Appl. No.: 18/495,948

(22) Filed: Oct. 27, 2023

Related U.S. Application Data
(60) Provisional application No. 63/420,424, filed on Oct. 28, 2022.

(51) Int. Cl. G01S 17/58; B60W 30/09; G01S 7/48; G01S 17/32; G01S 17/931

(52) U.S. Cl. CPC G01S 17/58; B60W 30/09; G01S 7/4808; G01S 17/32; G01S 17/931; B60W 2420/52; B60W 2554/4044

(57) ABSTRACT

Computing systems, methods, and non-transitory storage media are provided for obtaining a signal emitted from a Lidar, applying a frequency modulation to the signal to generate an up-scanning direction and a down-scanning direction of the signal, wherein the up-scanning direction and the down-scanning direction are symmetric, suppressing a carrier frequency of the signal in response to the applying of the frequency modulation, applying a frequency modulation to the carrier frequency by shifting a local oscillator to change a symmetry between the up-scanning direction and the down-scanning direction, or adding a phase modulation, directing the signal to a target, and simultaneously determining a velocity and a direction of motion of the target with respect to the Lidar based on frequencies of a reflected signal from the target in the up-scanning direction and in the down-scanning direction.

PRIORITY INFORMATION

This application claims the benefit under 35 U.S.C. 119(e) of U.S. Provisional Application No. 63/420,424, filed Oct. 28, 2022, the content of which is hereby incorporated in its entirety.

### FIELD OF THE INVENTION

This disclosure relates to approaches of improving performance of double sideband suppressed carrier (DSB-SC) modulation in coherent Lidar, in particular, for detection of magnitude and direction of speed.

### BACKGROUND

Lidar technology has a cornucopia of applications in fields such as aerospace, autonomous or semi-autonomous driving, and meteorology due to high speed of processing, high precision, and high accuracy. Current Lidar techniques include conventional time-of-flight (TOF) and frequency modulated continuous wave (FMCW) in coherent Lidar.

### SUMMARY

Various examples of the present disclosure can include computing systems, methods, and non-transitory computer readable media having instructions that, when executed, cause one or more processors of the computing systems to perform: obtaining a signal emitted from a Lidar; applying a frequency modulation to the signal to generate an up-scanning direction and a down-scanning direction of the signal, wherein the up-scanning direction and the down-scanning direction are symmetric; suppressing a carrier frequency of the signal in response to the applying of the frequency modulation; in response to suppressing the carrier frequency, applying a frequency modulation to the carrier frequency by shifting a local oscillator to change a symmetry between the up-scanning direction and the down-scanning direction, or adding a phase modulation; in response to applying the frequency modulation to the carrier frequency, directing the signal to a target; and simultaneously determining a velocity and a direction of motion of the target with respect to the Lidar based on frequencies of a reflected signal from the target in the up-scanning direction and in the down-scanning direction.

In some examples, the up-scanning direction and the down-scanning direction have a same magnitude of slope, wherein the magnitude of slope indicates a rate of change of respective frequencies in the up-scanning direction and the down-scanning direction over time.

In some examples, the changing of the symmetry comprises shifting the local oscillator to increase a magnitude of the slope in the up-scanning direction and decreasing a magnitude of the slope in the down-scanning direction.

In some examples, the simultaneously determining of the velocity and the direction of motion is based on a difference between the frequencies of the reflected signal in the up-scanning direction and in the down-scanning direction.

In some examples, the claimed system further comprises a directly modulated laser to perform the modulating of the carrier frequency.

In some examples, the instructions cause the system to perform adding the phase modulation, the phase modulation comprising a phase modulation serrodyne frequency shift (PS-SFS).

In some examples, the simultaneously determining a velocity and a direction of motion of the target with respect to the Lidar is based on a modulation rate of sawtooth scanning.

In some examples, the simultaneously determining a velocity and a direction of motion of the target with respect to the Lidar is based on an offset by which a local oscillator of the Lidar is shifted.

In some examples, the instructions cause the system to perform navigating a vehicle based on the velocity and the direction of motion of the target.

In some examples, the velocity of the target is at most 300 kilometers per hour.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the invention are utilized, and the accompanying drawings of which:

FIG. 1 illustrates an example of DSB-SC sidebands.

FIG. 2 illustrates an implementation in which a FMCW Lidar emits light onto a target.

FIG. 3 illustrates the creation or generating of different frequency shifts, excursions, sequences, or patterns between the up-scanning direction and the down-scanning direction.

FIG. 4 illustrates a schematic implementation including physical components that perform the creation or generating of different frequency shifts, excursions, sequences, or patterns between the up-scanning direction and the down-scanning direction.

FIG. 5 illustrates an implementation of an application of DSB-SC, in particular, of applying same chirp rates to the up-scanning direction compared to the down-scanning direction.

FIG. 6 illustrates a schematic implementation including physical components that perform the application illustrated in FIG. 5.

FIG. 7 illustrates a phase modulation in accordance with FIGS. 5-6.

FIGS. 8-14 illustrate examples of vehicle navigation scenarios based on a target heading direction and velocity as determined using the implementation in FIGS. 2-7, in accordance with various examples

FIG. 15 illustrates, in accordance with various examples, a flowchart of an example method consistent with FIGS. 1-14, embodied in a computing component.

FIG. 16 illustrates a block diagram of an example computer system in which any of the embodiments described herein may be implemented.

### DETAILED DESCRIPTION

TOF (time of flight) Lidar technologies may provide accurate tracking of targets via emitting pulses of light and measuring time until each pulse reflects back to the sensor. However, one shortcoming of TOF technologies is that TOF is unable to directly detect a velocity of a target. Meanwhile, FMCW may simultaneously detect a velocity and a position of a target based on a Doppler frequency shift. A Doppler frequency shift resulting from the velocity of the target is different in opposite scanning directions of the frequency modulation, the up-scanning and down-scanning directions. Therefore, the distance between the sensor and the target, and the speed of the target, may be obtained by computing the average and the difference of the two beat frequencies in the up-scanning and the down-scanning directions. The foregoing describes an implementation of DSB-SC modulated FMCW that utilizes two modulation schemes for double sideband modulation to resolve current shortcomings of beatnote interference at low speeds and an inability to detect a direction of motion of the target.

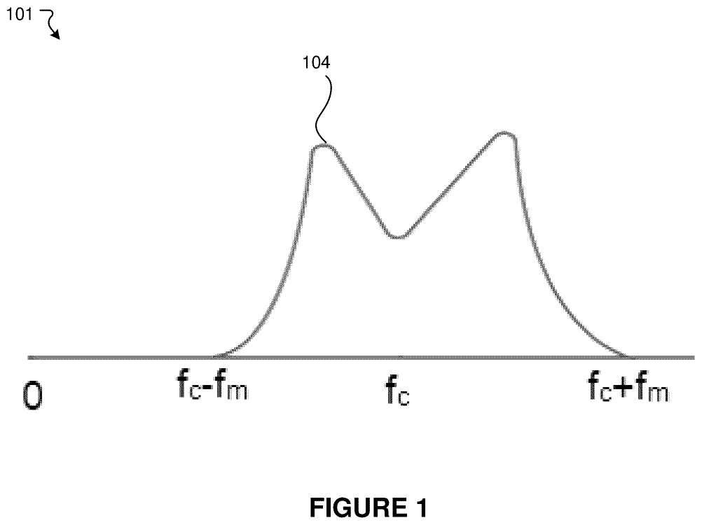

In some implementations, an electro-optic modulator (EOM) may break up a symmetry of the DSB-SC sidebands. An example of DSB-SC sidebands is illustrated in FIG. 1. FIG. 1 illustrates a frequency spectrum 101 including a sideband 104 centered around f_{c}. fₘ represents a modulation frequency. f_{c} represents a carrier frequency.

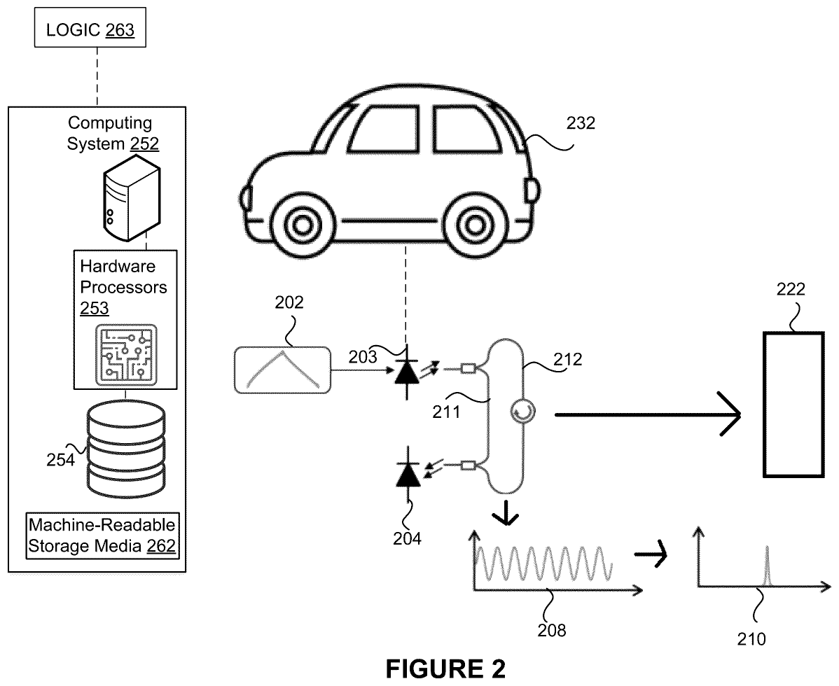

FIG. 2 illustrates an implementation in which a laser source 203, following application of an input voltage 202, is directed to two separate paths, a reference path 211 as a local oscillator, and a probe path 212 towards a target 222. The laser source 203 may be a linear frequency modulated chirped laser. A photodetector 204 may detect an interference signal of light between the probe path 212 and the reference path 211, which may be manifested as a beat signal 208. The beat signal 208 may be sinusoidal and a frequency of the beat signal may be proportional to a distance to the target. A Fourier Transform may convert this beat signal into a peak 210 in a frequency domain. If the target 222 is moving, an up-chirp, or an up-scanning direction, and down-chirp, or a down-scanning direction, of the laser source 203 may simultaneously detect a velocity and distance.

The laser source 203 may be disposed on a moving object, such as a vehicle 232. For example, at least one of the laser source 203 or the target 222 may be moving. In some examples, a maximum relative velocity between the laser source 203 and the target 222 may be approximately 300 kilometers per hour, in which both the laser source 203 and the target 222 are moving in opposite directions at approximately 150 kilometers per hour. In another example, either the laser source 203 or the target 222 may be approximately stationary and one of the laser source 203 or the target 222 may be moving at approximately 150 kilometers per hour. A range of relative velocities may be between 150 kilometers per hour and 300 kilometers per hour.

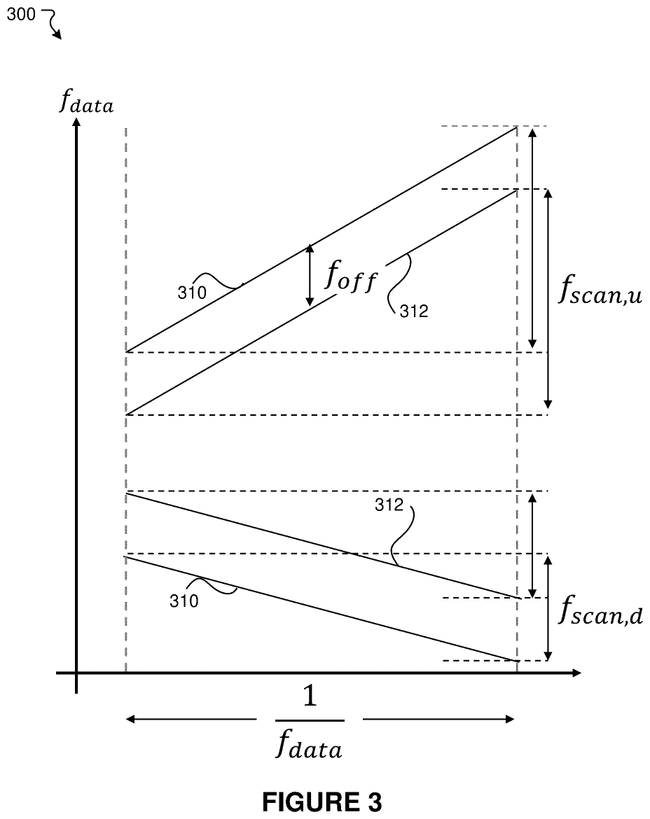

The laser source 203 may be associated with a computing system 252 which includes one or more processors and memory. Processors can be configured to perform various operations by interpreting machine-readable instructions, for example, from a machine-readable storage media 262. The processors can include one or more hardware processors 253. In some examples, one or more of the hardware processors 253 may be combined or integrated into a single processor, and some or all functions performed by one or more of the hardware processors 253 may not be spatially separated, but instead may be performed by a common processor. The hardware processors 253 may further be connected to, include, or be embedded with logic 263 which, for example, may include protocol that is executed to carry out the functions of the hardware processors 253. These functions may include any of those described in the foregoing figures, such as FIGS. 3-15. The one or more hardware processors 253 may also be associated with storage 254, which may encompass a permanent storage or cache to store any outputs or intermediate outputs from the hardware processors 253.

FIG. 3 illustrates the creation or generating of different frequency shifts, excursions, sequences, or patterns between the up-scanning direction f_{scan,u} and the down-scanning direction f_{scan,d}. The creation or generating of different frequency shifts, via modulating of a carrier frequency using a directly modulated laser (DML) such as a tunable diode laser (TDL), may result in different magnitudes of slopes, indicating a change in scanning frequency over time, between the up-scanning direction and the down-scanning direction. In particular, a slope in the up-scanning direction may be increased while a slope in the down-scanning direction may be decreased. By differentiating magnitudes of the frequency of the up-scanning direction compared to the frequency of the down-scanning direction, upon detection of two different frequencies that are reflected by the target 222, the frequency of the up-scanning direction may be distinguished from the frequency of the down-scanning direction.

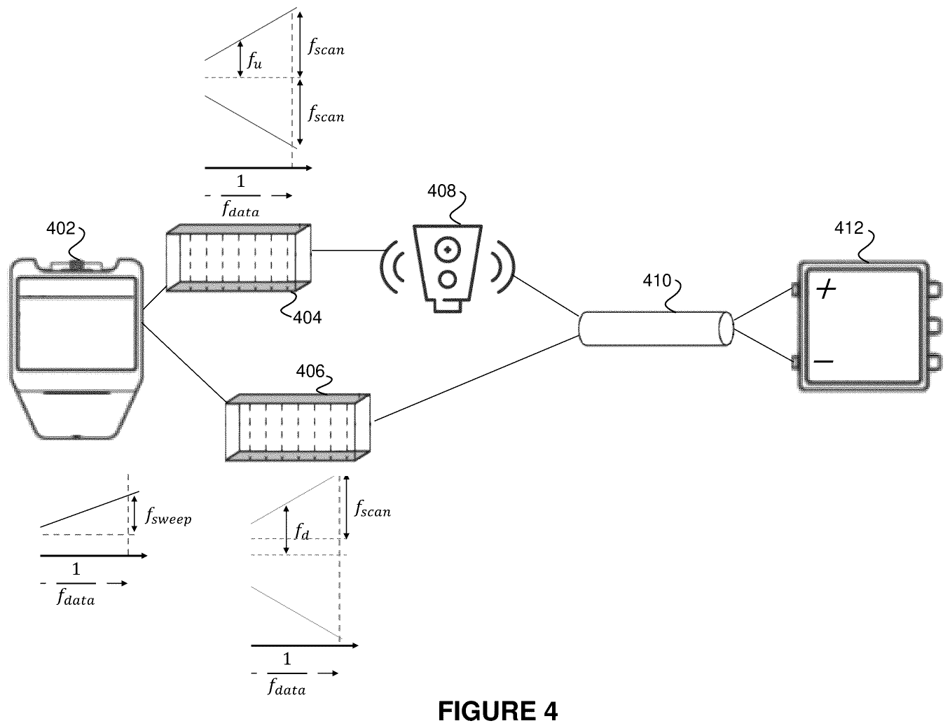

In FIG. 3, a plot 300 illustrates frequency on a y-axis and time on a x-axis. In the plot 300, a signal scan 312 is offset from a reference scan 310 by f_{off}. More particularly, the signal scan 312 indicates frequency chirping of a signal path and the reference scan 310 indicates frequency chirping of a local oscillator path and is internally generated by the laser source 203. As will be explained with respect to FIG. 4, upon obtaining a difference between the frequencies in the up-scanning and the down-scanning directions and dividing by two, a speed of the target may be obtained. Using the different frequency shifts in FIG. 3, both a direction and a magnitude of velocity of the target may be acquired.

A doppler frequency shift

$$Δ {f}_{D} = \frac{2 {v}_{r}}{c} {f}_{opt}$$

is proportional to a relative velocity (vᵣ) between the target (e.g., 222 in FIG. 2) and the laser source 203, where fₒₚₜ is the optical carrier frequency. When a carrier frequency of the light from the laser source 203 is 200 THz, the Doppler frequency shift falls into the range of [−50 MHz, 100 MHz]. i.e., Δf_{D} ∈ [−50, 100]MHz.

In order to avoid detection ambiguity due to large speed at short distance, a local oscillator of the laser source 203 may be shifted to a higher frequency by a magnitude of (f_{off}) to achieve heterogeneous detection. Here, f_{off}>max {Δf_{D}}, which is 100 MHz in the scenario described above. Assuming the target 222 is at a distance, with respect to the laser source 203, of Δ_{z}, then a beat note or a beat frequency fᵤ from the up-scanning direction is:

$${f}_{u} = {f}_{off} - Δ {f}_{D} + \frac{2 Δ z}{c} {f}_{data} \cdot {f}_{scan , u}$$

And the beat frequency or beat note f_{d} from the down-scanning direction is:

$${f}_{d} = {f}_{off} - Δ {f}_{D} + \frac{2 Δ z}{c} {f}_{data} \cdot {f}_{scan , d}$$

Here, c is the speed of light and f_{data} is a datapoint rate or frequency, or a modulation rate of sawtooth scanning. Since f_{scan,u}>f_{scan,d}, fᵤ and f_{d} may be distinguished without ambiguity. Therefore, values of Δz and Δf_{D} may be obtained or derived unambiguously:

$$Δ z = \frac{( {f}_{u} + {f}_{d} + 2 {f}_{off} ) c}{{f}_{data} \cdot ( {f}_{scan , u} + {f}_{scan , d} )} \\ Δ {f}_{D} = \frac{{f}_{scan , u} {f}_{d} - {f}_{scan , d} {f}_{u} - ( {f}_{scan , u} - {f}_{scan , d} ) {f}_{off}}{{f}_{scan , u} + {f}_{scan , d}}$$

In order to avoid detection ambiguity due to large speed at short distance, a local oscillator of the laser source 203 may be shifted to a higher frequency by a magnitude of (f_{off}) to achieve heterogeneous detection. Here, f_{off}>max {Δf_{D}}, which is 100 MHz in the scenario described above. Assuming the target 222 is at a distance, with respect to the laser source 203, of Δ_{z}, then a beat note or a beat frequency fᵤ from the up-scanning direction is:

$${f}_{u} = {f}_{off} - Δ {f}_{D} + \frac{2 Δ z}{c} {f}_{data} \cdot {f}_{scan , u}$$

And the beat frequency or beat note f d from the down-scanning direction is:

$${f}_{d} = {f}_{off} - Δ {f}_{D} + \frac{2 Δ z}{c} {f}_{data} \cdot {f}_{scan , d}$$

Here, c is the light speed and f_{data} is a datapoint rate or frequency. Since f_{scan,u}>f_{scan,d}, fᵤ and f_{d} may be distinguished without ambiguity. Therefore, values of Δz and Δf_{D} may be obtained or derived unambiguously:

$$Δ z = \frac{( {f}_{u} + {f}_{d} + 2 {f}_{off} ) c}{{f}_{data} \cdot ( {f}_{scan , u} + {f}_{scan , d} )} \\ Δ {f}_{D} = \frac{{f}_{scan , u} {f}_{d} - {f}_{scan , d} {f}_{u} - ( {f}_{scan , u} - {f}_{scan , d} ) {f}_{off}}{{f}_{scan , u} + {f}_{scan , d}}$$

FIG. 4 illustrates a schematic implementation that includes a tunable diode laser (TDL) 402, electro-optic modulators (EOMs) 404 and 406 that correspond to the beat frequency fᵤ from the up-scanning direction and the beat frequency or beat note f_{d} from the down-scanning direction, respectively, a Lidar 408, one or more optical couplers 410, and a photodetector 412, such as a balanced photodetector (BPD). Thus, the EOM 404 receives the signal from the up-scanning direction and the EOM 406 receives the signal from the down-scanning direction, corresponding to the local oscillator, for example, from the reference path 211, and has a higher offset frequency. The tunable diode laser (TDL) 402 may be implemented as the laser source 203 of FIG. 2. Light collected by the Lidar 408 may be combined from the two paths of the EOM 404 and the EOM 406 via a beam combiner, manifested as free space or a fiber, and transmitted to the photodetector 412 for low noise coherent detection. The Lidar 408 may be mechanical, non-mechanical, or hybrid. In order to create or trigger different chirp rates for the up-scanning direction compared to those for the down-scanning direction, a carrier frequency may be swept along with the modulation from the EOM. FIG. 4 illustrates that the manner in which the TDL frequency is swept entails attaining a frequency excursion of f_{sweep} from zero at a rate of f_{data}. In such a scheme,

f_{scan,u}=f_{scan}+f_{sweep};

f_{scan,d}=f_{scan}−f_{sweep};

wherein f_{scan} is the maximum frequency chirp arising from the DSB-SC.

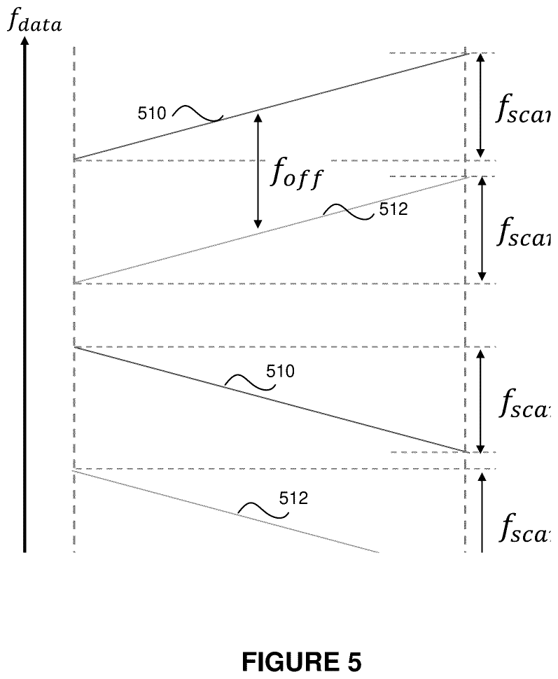

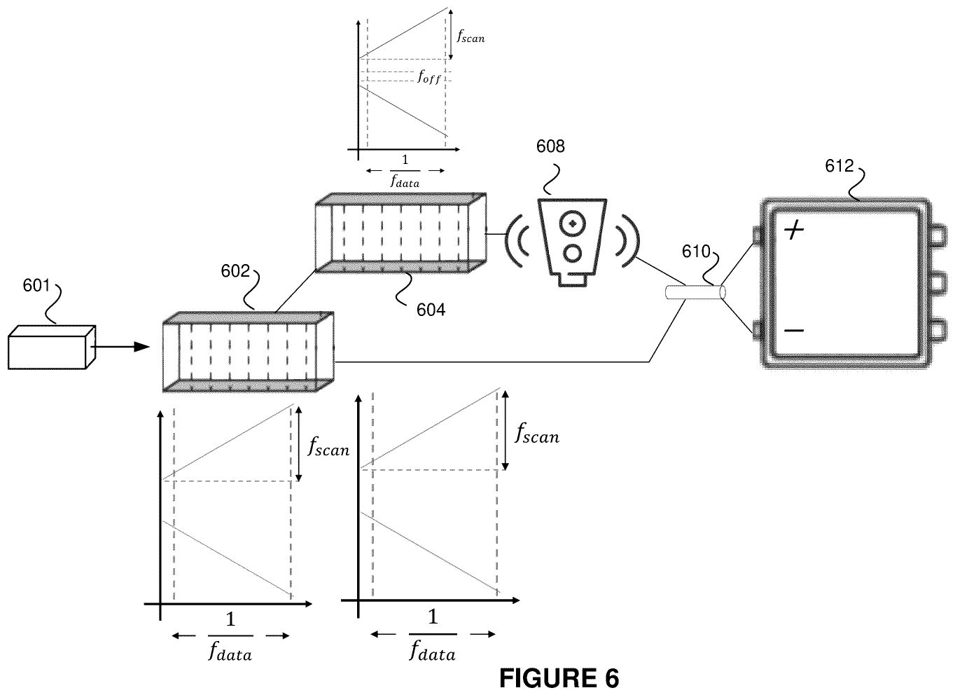

FIG. 5 illustrates a different implementation of an application of DSB-SC, in particular, of applying same chirp rates to the up-scanning direction compared to the down-scanning direction. In FIG. 5, a curve 510 represents frequency chirping of a signal path and a curve 512 represents frequency chirping of a local oscillator (e.g., reference) path. A frequency offset in FIG. 5 is greater than that in FIG. 3. In FIG. 5, a phase modulation is applied in the signal path to shift to a higher offset frequency. FIG. 6 illustrates a schematic implementation that includes a first EOM 602 in a signal path for DSB-SC, which receives a continuous wave (CW) laser 601, a second EOM 604 in a signal path for phase modulation serrodyne frequency shifter (PS-SFS), a Lidar 608, an optical coupler 610 (optional), and a photodetector 612. The CW laser 601 is transmitted to the first EOM 602, then this transmitted laser may be divided into two paths, a signal path and a reference path. The reference path remains unchanged. The light may be transmitted through the Lidar 608.

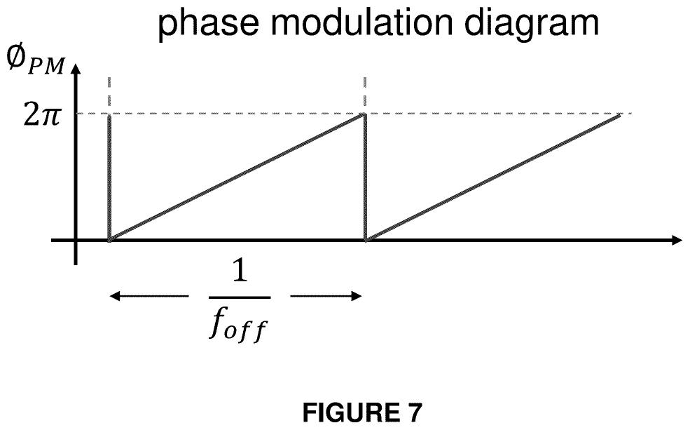

FIG. 7 illustrates a phase modulation in accordance with FIGS. 5 and 6. By modulating the phase from zero to 2π at frequency of f_{off}, the input signal could be shift by frequency of f_{off}. Φₘ is the phase of the input signal. In the second scheme, the chirp rates for up scan and down scan are the same, however, The CS-DSM of the signal path is shifted to a higher offset frequency (f_{off}). So that the beat note from the up scan (fᵤ) and down scan (f_{d}) could be expressed as:

$${f}_{u} = {f}_{off} + Δ {f}_{D} - \frac{2 Δ z}{c} {f}_{data} \cdot {f}_{scan} \\ {f}_{d} = {f}_{off} + Δ {f}_{D} - \frac{2 Δ z}{c} {f}_{data} \cdot {f}_{scan}$$

The Doppler effect affects the up-scanning beat note and down-scanning beat note in the same way. Furthermore, as long as the target is at certain distance, i.e., Δz≢0, f_{d} is always larger than f_{d}. To avoid ambiguity for the beat note of up scan (fᵤ>0), the f_{off} needs to meet the condition: f_{off}>f_{MAX}−MIN{Δf_{D}}, where

$${f}_{MAX} = \frac{2 MAX \{ Δ z \}}{c} {f}_{data} \cdot {f}_{scan} .$$

In such scheme, the distance Δz and Doppler effect Δf_{D} may unambiguously be obtained:

$$Δ z = \frac{c ( {f}_{d} - {f}_{u} )}{4 {f}_{data} {f}_{scan}} \\ Δ {f}_{D} = \frac{{f}_{u} + {f}_{d} - 2 {f}_{off}}{2}$$

In this scheme, f_{off} is achieved through phase modulation serrodyne frequency shift (PS-SFS). When the phase of the input signal is modulated from 0 to 2π at a rate of f_{off}, the input signals carrier frequency may be shifted by a frequency of f_{off}.

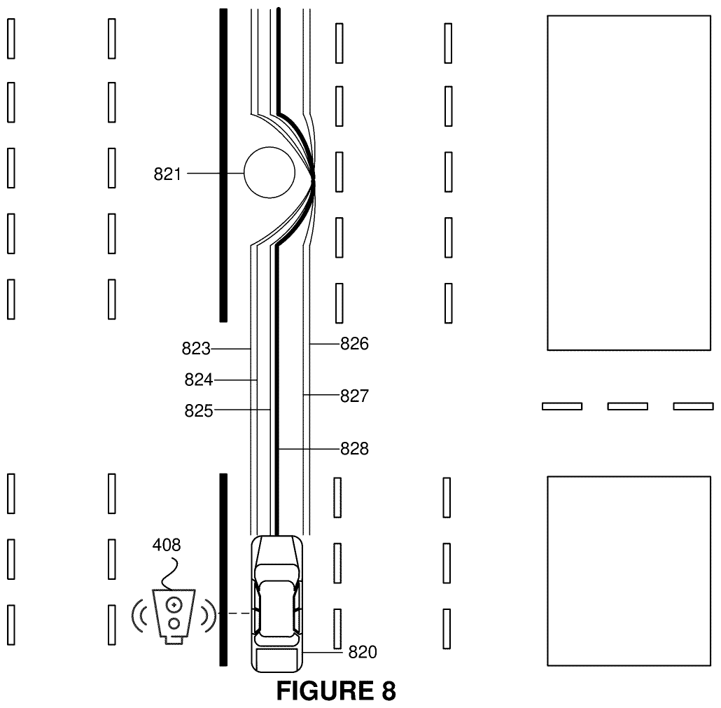

FIGS. 8-14 illustrate navigation scenarios, in which a determination of velocity and a direction of a target may be used to determine one or more navigation actions of a vehicle. In FIG. 8, a Lidar (e.g., the Lidar 408 or 608 and/or incorporating the laser source 203) on a vehicle 820 may detect a target such as an obstacle 821, such as a pothole, bump, or rock on a road. One or more processors, such as the hardware processors 253, associated with the Lidar 408 or 608, may determine or predict a direction of motion and a velocity of the obstacle 821 using any of the aforementioned techniques described in FIGS. 1-7. The hardware processors 253 may determine a driving action or maneuver of the vehicle 820 in order to pass or avoid the obstacle 821, based on the determined or predicted direction of motion and the velocity of the obstacle 821. The determined driving action or maneuver of the vehicle 820 may be based on a size and location of the obstacle 821 and/or a predicted location when the vehicle 820 traverses the obstacle 821. In some examples, the hardware processors 253 may determine that the obstacle 821 is too large and/or too dangerous for the vehicle 820 to pass without swerving, or to straddle. For example, the hardware processors 253 may predict that if the vehicle 820 attempts to directly drive over the obstacle 821 without swerving, one or more wheels of the vehicle 820 may hit the obstacle 821 and cause the previously stationary obstacle 821 to roll to another adjacent lane or to an opposite side of the road, thereby increasing a danger to another vehicle on the adjacent lane or the opposite side of the road. The hardware processors 253 may predict a change in trajectory of the another vehicle on the adjacent lane or the opposite side of the road as a result of the obstacle 821 rolling. The hardware processors 253 may further predict a change in trajectory of the vehicle 820 itself as a result of hitting the obstacle 821, such as a change in a velocity, acceleration, pose, orientation, and/or equilibrium of the vehicle 820. If the hardware processors 253 predicts that the change in the trajectory of the vehicle 820, after hitting the obstacle 821, exceeds an allowable range, or that the change in the trajectory of the another vehicle exceeds an allowable range, the hardware processors 253 may determine that the vehicle 820 should swerve to avoid the obstacle 821. The hardware processors 253 may adjust a trajectory of the vehicle 820 to avoid the obstacle 821. The hardware processors 253 may select from potential trajectories 823, 824, 825, 826, 827, and 828. The potential trajectories 823, 824, 825, 826, 827, and 828 may be based on historical data of previous trajectories in similar conditions determined by size of obstacle, traffic density, road conditions, lighting conditions, and/or weather conditions. For example, the potential trajectories 823, 824, 825, 826, 827, and 828 may be determined based on a recent driving history of the vehicle 820. The potential trajectories 823, 824, 825, 826, 827, and 828 may be recent actual trajectories, for example, during a past year, month, or week, that have highest safety metrics. The hardware processors 253 may select the trajectory 828, based on predicted impacts to the trajectory 828, to a trajectory of the obstacle 821, and to a trajectory of another nearby vehicle that may be affected by the obstacle 821. For example, the hardware processors 253 may predict that the vehicle 820, while following the trajectory 828, will not hit the obstacle 821, and thus, the obstacle 821 will not change its trajectory and remain stationary. The hardware processors 253 may cause the vehicle 820 to navigate or maneuver past the obstacle 821 along the trajectory 828. After following the trajectory 828, the hardware processors 253 may determine an actual impact on the trajectory 828, the trajectory of the obstacle 821, and the trajectory of the nearby vehicle. Thus, if the hardware processors 253 determine that the vehicle 820 actually hit the obstacle 821 while following the trajectory 828, the hardware processors 253 may update or adjust the predicted impacts to the trajectory 828, to the trajectory of the obstacle 821, and to the trajectory of another nearby vehicle. The predicted impacts may be stored in a model. The updating or adjusting the predicted impacts may encompass updating the model. As a result, using the updated or adjusted predicted impacts of the updated or adjusted model, in subsequent situations, potential trajectories will place more distance between the vehicle 820 and the obstacle 821.

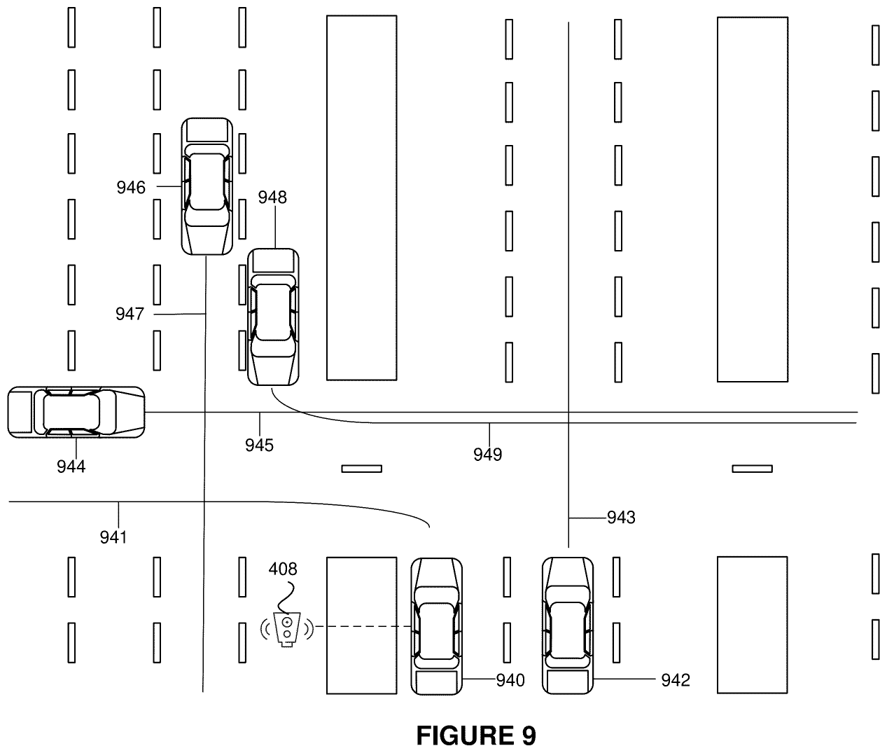

In FIG. 9, hardware processors (e.g., the hardware processors 253) associated with a Lidar of a vehicle 940 (e.g., the Lidar 408 or 608 and/or incorporating the laser source 203) may sense other vehicles 942, 944, 946, and 948 in an environment. The hardware processors 253 may determine or predict a direction of motion and a velocity of the other vehicles 942, 944, 946, and 948 using any of the aforementioned techniques described in FIGS. 1-7. The hardware processors 253 may determine a driving action or maneuver of the vehicle 940 in order to account for the direction of motion and the velocity of the other vehicles 942, 944, 946, and 948, for example, while the vehicle 940 is attempting a left turn. The determined driving action or maneuver of the vehicle 940 may also be based on a size and location of the vehicles 942, 944, 946, and 948. The hardware processors 253 may predict trajectories 943, 945, 947, and 949 of the other vehicles 942, 944, 946, and 948, respectively, based on the determined directions of motion and the velocities of the other vehicles 942, 944, 946, and 948, while predicting changes in the trajectories 943, 945, 947, and 949, as a result of the vehicle 940 following a selected trajectory 941. The hardware processors 253 may further predict a change in the selected trajectory 941 of the vehicle 940 itself, resulting from interaction with the vehicles 942, 944, 946, and 948. If the hardware processors 253 predict that the change in the trajectory of the vehicle 940 itself exceeds an allowable range, or that the change from one or more of the predicted trajectories 943, 945, 947, and 949, exceeds an allowable range, the hardware processors 253 may update the selected trajectory 941 or select another trajectory, so that the changes that fall outside respective allowable ranges are within the allowable ranges. For example, the hardware processors 253 may predict that the vehicle 940, while following the trajectory 941, will maintain at least a predetermined distance from each of the predicted trajectories 943, 945, 947, and 949, without causing any of the vehicles 942, 944, 946, and 948 to slow down by more than an acceptable amount, or to deviate from each of the respective predicted trajectories 943, 945, 947, and 949. After following the trajectory 941, the hardware processors 253 may determine an actual change or impact on the selected trajectory 941, and actual changes or impacts to the predicted trajectories 943, 945, 947, and 949. If the hardware processors 253 determine that at least one of the actual trajectories of the vehicles 942, 944, 946, and/or 948 deviate from the predicted trajectories 943, 945, 947, and 949, respectively, or that at least one of the vehicles 942, 944, 946, and 948 decrease their respective velocities by more than an acceptable amount, the hardware processors 253 may update or adjust the predicted trajectories 943, 945, 947, and 949, or a predicted impact on the predicted trajectories 943, 945, 947, and 949. The predicted trajectories 943, 945, 947, and 949 may be stored in a model. The updating or adjusting the predicted trajectories 943, 945, 947, and 949 or predicted impacts on the predicted trajectories 943, 945, 947, and 949 may encompass updating the model. For example, if the hardware processors 253 determine that the trajectory 941 approaches too closely to one or the predicted trajectories, such as the predicted trajectory 943, so that the vehicle 942 must swerve, a result of this interaction may be stored in the model. The model may be updated so that next time, a selected trajectory will not approach too closely to one of the predicted trajectories. As a result, using the updated or adjusted predicted impacts of the updated or adjusted model, potential trajectories in subsequent interactions will place more distance between the vehicle 940 and predicted trajectories.

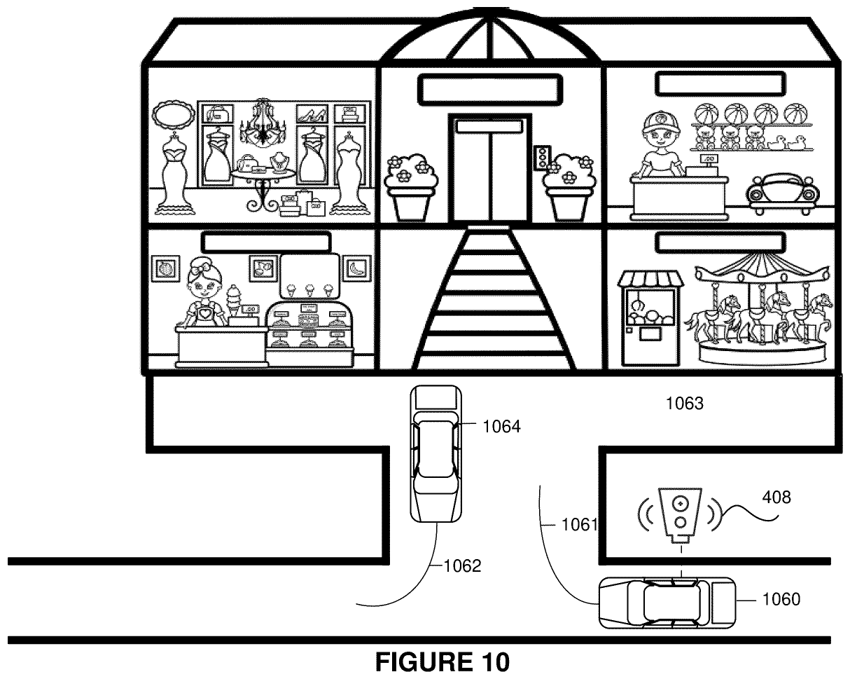

In FIG. 10, a computing system (e.g., the computing system 252, including the hardware processors 253) of a vehicle 1060, may sense other vehicles and surrounding conditions while the vehicle 1060 is turning into a parking lot 1063. The hardware processors 253 may be associated with a Lidar of the vehicle 1060 (e.g., the Lidar 408 or 608 and/or incorporating the laser source 203). In some examples, an entrance to the parking lot 1063 may not include clear lane dividers to separate vehicles entering the parking lot 1063 and vehicles such as a vehicle 1064 leaving the parking lot 1063. The hardware processors 253 may determine or predict a direction of motion and a velocity of the vehicle 1064 using any of the aforementioned techniques described in FIGS. 1-7. In such examples, the hardware processors 253 may select a trajectory, such as a trajectory 1061, for the vehicle 1060 to follow as the vehicle 1060 pulls into the parking lot 1063, based on the determined direction of motion and a velocity of the vehicle 1064. For example, the trajectory 1061 may be one-quarter of the way from one side (e.g., a right side) of the entrance and three-quarters of the way from an opposing side (e.g., a left side) of the entrance, so that enough room may be left for the vehicle 1064 that is also leaving the parking lot 1063 at a same time from an opposite side, as represented by a predicted trajectory 1062. The hardware processors 253 may determine a driving action or maneuver of the vehicle 1060 in order to account for the vehicle 1064. The determined driving action or maneuver of the vehicle 1060 may be based on a size and location of the vehicle 1064. The hardware processors 253 may predict the trajectory 1062, and predict a change in the trajectory 1062, as a result of the vehicle 1060 following the selected trajectory 1061. The hardware processors 253 may further predict a change in the selected trajectory 1061 of the vehicle 1060 itself, resulting from interaction with the vehicle 1064. If the hardware processors 253 predicts that the change in the trajectory of the vehicle 1060 itself exceeds an allowable range, or that the change from the predicted trajectory 1062 exceeds an allowable range, the hardware processors 253 may update the selected trajectory 1061 or select another trajectory, so that the changes that fall outside respective allowable ranges are within the allowable ranges. For example, the hardware processors 253 may predict that the vehicle 1060, while following the trajectory 1061, will maintain at least a predetermined distance from the predicted trajectory 1062, without causing the vehicle 1064 to slow down by more than an acceptable amount, or to deviate from the predicted trajectory 1062. After following the trajectory 1061, the hardware processors 253 may determine an actual change or impact to the trajectory 1061, and an actual change or impact to the predicted trajectory 1062 of the vehicle 1064. If the hardware processors 253 determine that the actual trajectory of the vehicle 1064 deviates from the predicted trajectory 1062, or that the vehicle 1064 decreases its velocity by more than an acceptable amount, the hardware processors 253 may update or adjust the predicted trajectory 1062, or a predicted impact on the predicted trajectory 1062 as a result of the vehicle 1060 following the trajectory 1061. The predicted trajectory 1062 may be stored in a model. The updating or adjusting the predicted trajectory 1062 and predicted impacts on the predicted trajectory 1062 may encompass updating the model. For example, if the hardware processors 253 determine that the trajectory 1061 approaches too closely to the predicted trajectory 1062, such that the vehicle 1064 actually swerves to avoid the vehicle 1060, a result of this interaction may be stored in the model. The model may be updated so that next time, a selected trajectory of the vehicle 1060 will not approach too closely to a predicted trajectory. As a result, using the updated or adjusted predicted impacts of the updated or adjusted model, potential trajectories in subsequent interactions will place more distance between the vehicle 1060 and predicted trajectories.

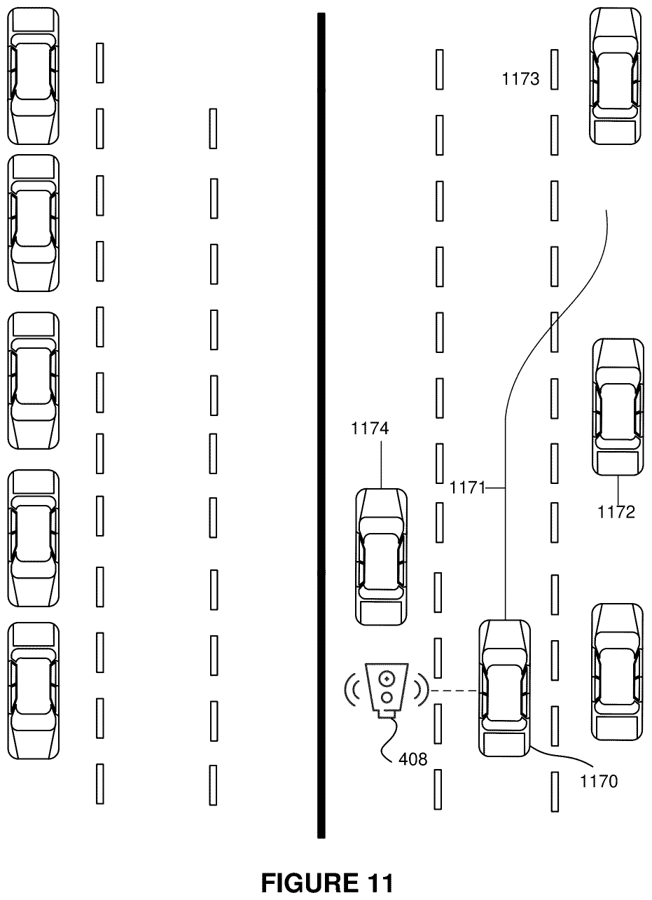

In FIG. 11, a computing system (e.g., the computing system 252, including the hardware processors 253) of a vehicle 1170, may sense other vehicles and surrounding conditions while the vehicle 1170 is pulling into a parking spot between vehicles 1172 and 1173, while maintaining at least a predetermined distance from a vehicle 1174 which may currently be driving and also trying to pull into the same parking spot. The hardware processors 253 may be associated with a Lidar of the vehicle 1170 (e.g., the Lidar 408 or 608 and/or incorporating the laser source 203). The hardware processors 253 may determine or predict a direction of motion and a velocity of the vehicle 1174 using any of the aforementioned techniques described in FIGS. 1-7 and predict a trajectory of the vehicle 1174 based on the determined direction of motion and velocity of the vehicle 1174. The hardware processors 253 may determine whether or not to compete with another vehicle such as the vehicle 1174 for a common parking spot, based on relative positions of the vehicle 1170 and 1174 and a predicted trajectory of the vehicle 1174, including a velocity, acceleration, and pose of the vehicle 1174. If the hardware processors 253 determine to try to obtain the parking spot, the hardware processors 253 may select a trajectory 1171. If the vehicle 1170 is either unsuccessful in obtaining the parking spot, or a distance between the vehicle 1171 and the vehicle 1174 becomes lower than a threshold distance while both the vehicle 1171 and the vehicle 1174 are trying to obtain the parking spot, the hardware processors 253 may store data of and a result of an interaction between the vehicle 1171 and the vehicle 1174 in a model, so that the vehicle 1170 can refine its decision making process in a similar future situation when the vehicle 1170 is attempting to pull into a parking spot.

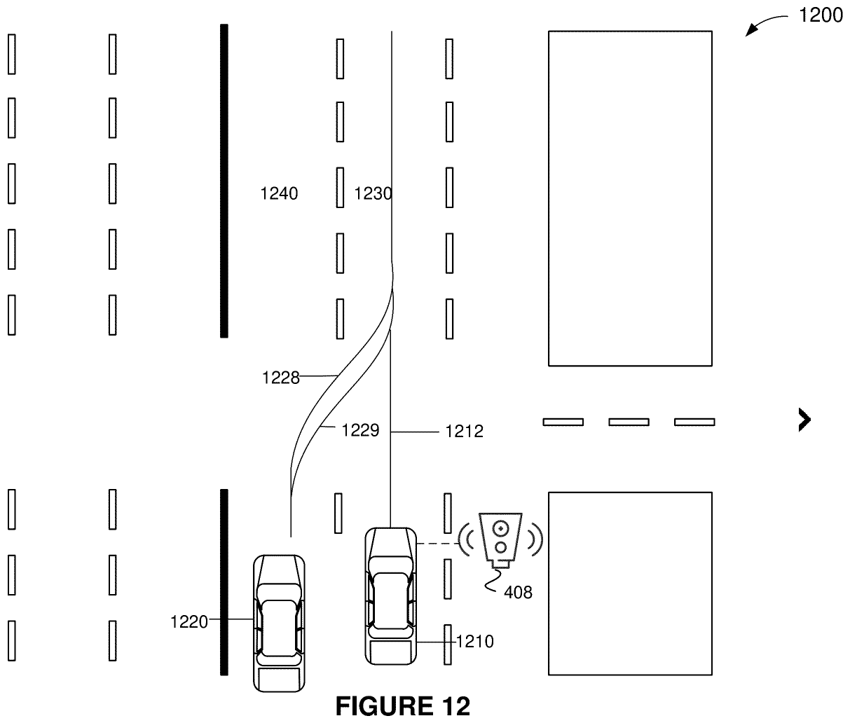

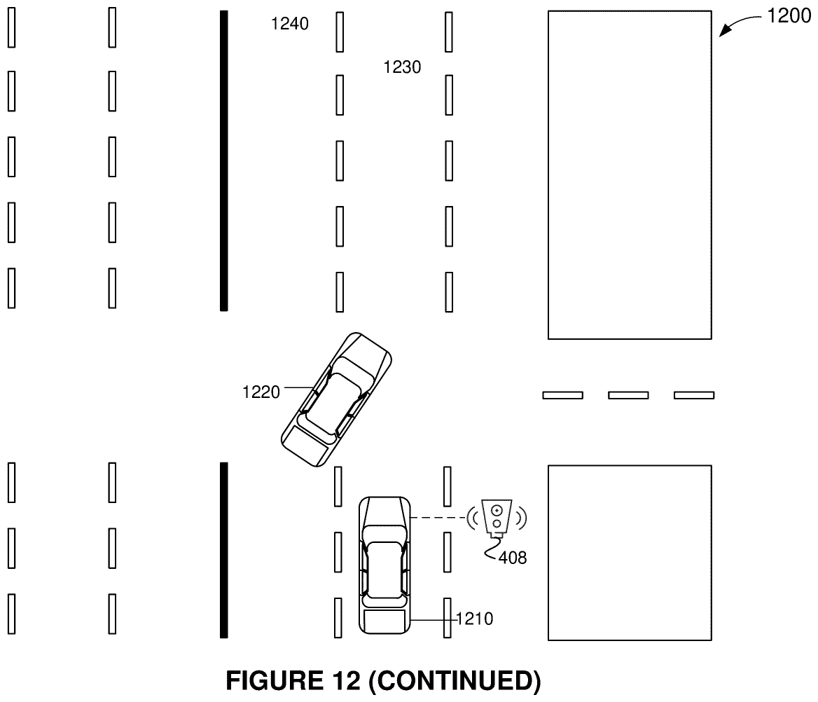

In FIG. 12, a computing system (e.g., the computing system 252, including the hardware processors 253) of a vehicle 1210 (e.g., the Lidar 408 or 608 and/or incorporating the laser source 203), may determine, based on data collected by the Lidar, a navigation action of the vehicle 1210. The vehicle 1210 may be driving in a lane 1230 according to a selected trajectory 1212. Another vehicle 1220, which may be an AV, may be driving in a lane 1340 to a left side of the vehicle 1210. The another vehicle 1220 may signal to the vehicle 1210 that the another vehicle 1220 intends to pass or overtake the vehicle 1210 and merge into the lane 1230. The vehicle 1210 may detect and recognize, via one or more hardware processors (e.g., the hardware processors 253), that the another vehicle 1220 intends to merge into the lane 1230. The hardware processors 253 may determine or predict a direction of motion and a velocity of the another vehicle 1220 using any of the aforementioned techniques described in FIGS. 1-7, and determine or estimate a trajectory of the another vehicle 1220 based on the determined or estimated trajectory. The hardware processors 253 may determine whether or not to allow the another vehicle 1220 to merge into the lane 1230. The determination may comprise predicting a trajectory 1228 of the another vehicle 1220 and a predicted change in the selected trajectory 1212 of the vehicle 1210, as a result of the vehicle 1210 allowing the another vehicle 1220 to merge into the lane 1230. For example, if a predicted change in the selected trajectory 1212 exceeds an allowable amount, the hardware processors 253 may not allow the another vehicle 1220 to merge into the lane 1230. For instance, a predicted change in the selected trajectory 1212 may comprise a predicted decrease in velocity of the vehicle 1210. If the vehicle 1210 allows the another vehicle 1220 to merge into the lane 1230, the hardware processors 253 may determine an actual change in the selected trajectory 1212 resulting from the merging of the another vehicle 1220, and determine an actual trajectory of the another vehicle 1220 during merging. If the actual change in the selected trajectory 1212 deviates from the predicted change in the selected trajectory 1212 by more than a threshold amount, if the actual change in the selected trajectory 1212 exceeds the allowable amount, or if the actual trajectory of the another vehicle 1220 during merging deviates from the predicted trajectory 1228, the hardware processors 253 may update or adjust the predicted trajectory 1228, or a predicted impact on the selected trajectory 1212, as a result of the vehicle 1210 following the trajectory 1212. The predicted trajectory 1228, and the predicted impact on the selected trajectory 1212, may be stored in a model. The updating or adjusting the predicted trajectory 1228 and predicted impact on the selected trajectory 1212 may encompass updating the model. For example, if the hardware processors 253 determine that the another vehicle 1220 follows an actual trajectory 1229, such that the vehicle 1210 must slow down by more than the allowable amount to keep a predetermined distance with the another vehicle 1220, a result of this interaction may be stored in the model. The model may be updated so that next time, the vehicle 1210 may be less likely to allow the another vehicle to merge into the lane 1230. Likewise, as the vehicle 1210 transmits updates to the model to other vehicles in a fleet or network, the other vehicles may also adjust their behaviors so they are less likely to try to merge in such situations.

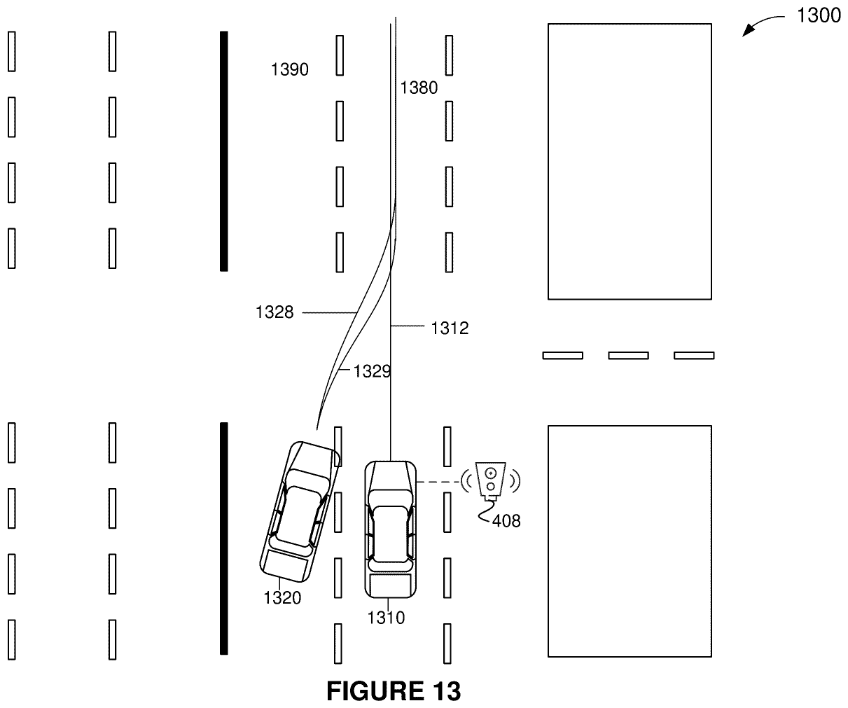

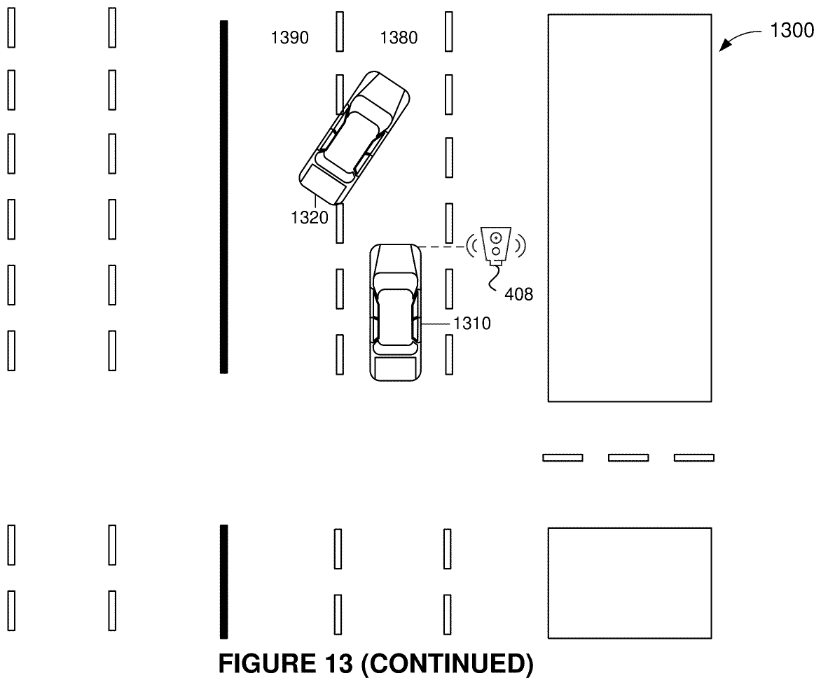

In FIG. 13, a computing system (e.g., the computing system 252, including the hardware processors 253) of a vehicle 1310 (e.g., the Lidar 408 or 608 and/or incorporating the laser source 203), may determine, based on data collected by the Lidar, a navigation action of the vehicle 1310. The vehicle 1310 may be driving in a lane 1380, according to a selected trajectory 1312. Another vehicle 1320, which may be an AV, may be driving in a lane 1390 to a left side of the vehicle 1310. The another vehicle 1320 may urgently be attempting to merge into the lane 1380 without properly signaling to the vehicle 1310, that the another vehicle 1320 intends to pass or overtake the vehicle 1310 and merge into the lane 1380. The vehicle 1310 may detect and recognize, via the hardware processors 253, that the another vehicle 1320 intends to merge into the lane 1380. The hardware processors 253 may determine or predict a moving direction and a velocity of the another vehicle 1320 using any of the aforementioned techniques described in FIGS. 1-7, predict a trajectory of the another vehicle 1320 based on the moving direction or the velocity, and infer or predict any point at which the another vehicle 1320 intends to merge into the lane 1380. The hardware processors 253 may determine whether or not to permit the another vehicle 1320 to merge into the lane 1380 by slowing down, or to speed up in order to move in front of the another vehicle 1320. The determination may comprise predicting a trajectory 1328 of the another vehicle 1320 and a predicted change in the selected trajectory 1312 of the vehicle 1310, as a result of the vehicle 1310 allowing the another vehicle 1320 to merge into the lane 1380, or as a result of speeding up. For example, if a predicted change in the selected trajectory 1312 exceeds an allowable amount, as a result of allowing the another vehicle 1320 to merge into the lane 1380, the hardware processors 253 may determine not to allow the another vehicle 1320 to merge into the lane 1380. For instance, a predicted change in the selected trajectory 1312 may comprise a predicted decrease in velocity of the vehicle 1310. If the vehicle 1310 allows the another vehicle 1320 to merge into the lane 1380, the hardware processors 253 may determine an actual change in the selected trajectory 1312 resulting from the merging of the another vehicle 1320, and determine an actual trajectory of the another vehicle 1320 during merging. If the actual change in the selected trajectory 1312 deviates from the predicted change in the selected trajectory 1312 by more than a threshold amount, if the actual change in the selected trajectory 1312 exceeds the allowable amount, or if the actual trajectory of the another vehicle 1320 during merging deviates from the predicted trajectory 1328, the hardware processors 253 may update or adjust the predicted trajectory 1328, or a predicted impact on the selected trajectory 1312, as a result of the vehicle 1310 following the trajectory 1312. The predicted trajectory 1328, and the predicted impact on the selected trajectory 1312, may be stored in a model. The updating or adjusting the predicted trajectory 1328 and predicted impact on the selected trajectory 1312 may encompass updating the model. For example, if the hardware processors 253 determine that the another vehicle 1320 follows an actual trajectory 1329, such that the vehicle 1310 must slow down by more than the allowable amount to keep a predetermined distance with the another vehicle 1320, a result of this interaction may be stored in the model. The model may be updated so that next time, the vehicle 1310 may be less likely to allow the another vehicle to merge into the lane 1330 so that the vehicle 1310 instead will speed up to pull in front of another vehicle attempting to merge into a lane without signaling. Likewise, as the vehicle 1310 transmits updates to the model to other vehicles in a fleet or network, the other vehicles may also adjust their behaviors so they are less likely to try to merge in such situations.

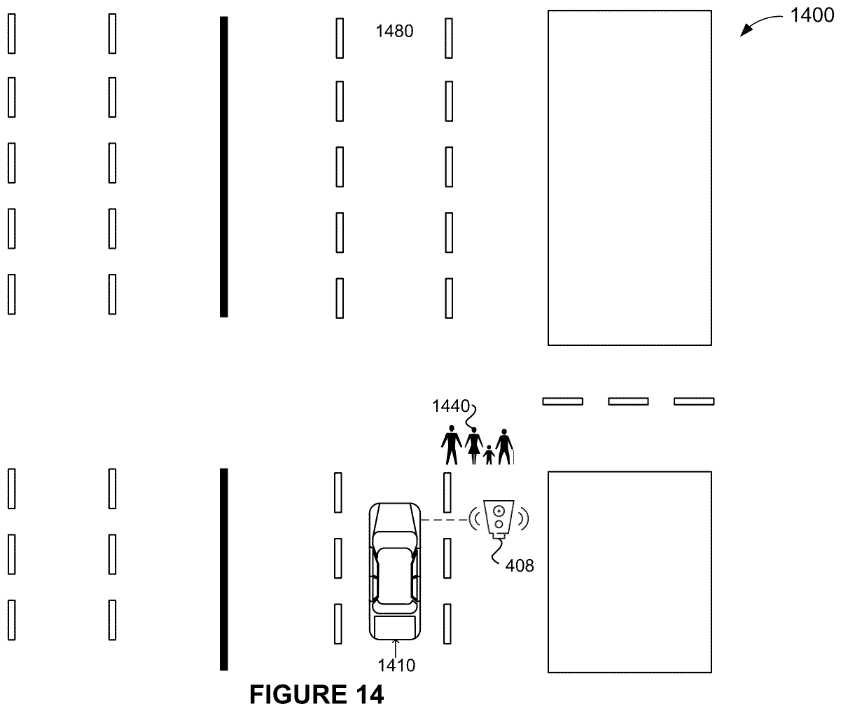

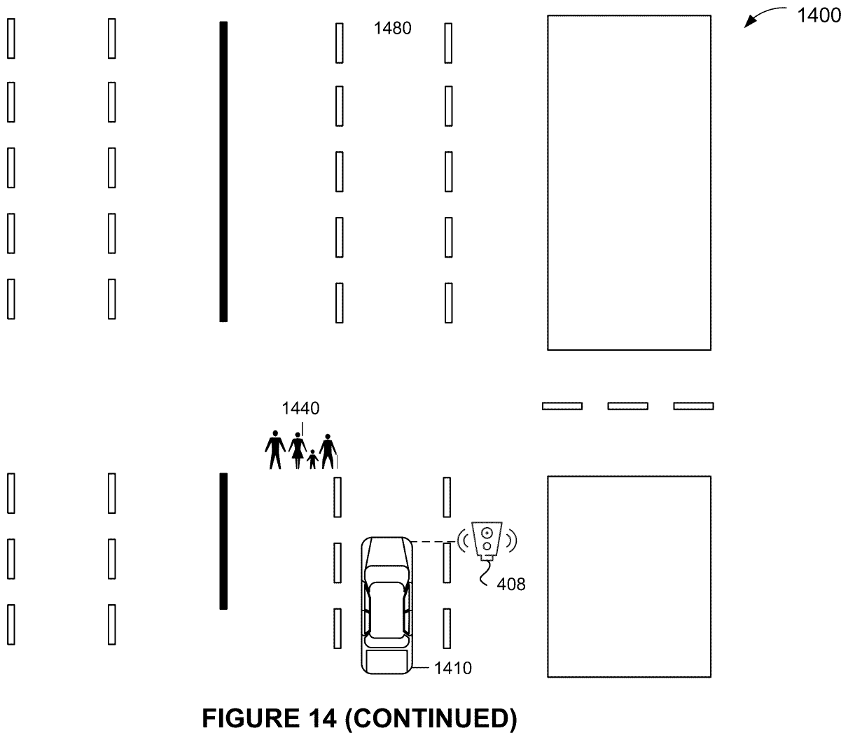

In FIG. 14, a computing system (e.g., the computing system 252, including the hardware processors 253) of a vehicle 1410 (e.g., the Lidar 408 or 608 and/or incorporating the laser source 203), may determine, based on data collected by the Lidar, a navigation action of the vehicle 1410. The vehicle 1410 may be driving in a lane 1480. The vehicle 1410 may detect and recognize, via the hardware processors 253, one or more pedestrians 1440 that intend to cross a street. The vehicle 1410 may determine or predict a moving direction and a velocity of the pedestrians 1440, individually and/or collectively, using any of the aforementioned techniques described in FIGS. 1-7, predict a trajectory of the pedestrians 1440 based on the moving direction or the velocity, and predict a delay time as a result of yielding to the pedestrians 1440. After the pedestrians 1440 have finished crossing the street, the hardware processors 253 may determine an actual delay time as a result of yielding to the pedestrians 1440. If the actual delay time deviates from the predicted delay time by more than a threshold amount, the hardware processors 253 may update the predicted delay time to account for the deviation, and incorporate the updated predicted delay time in future measurements.

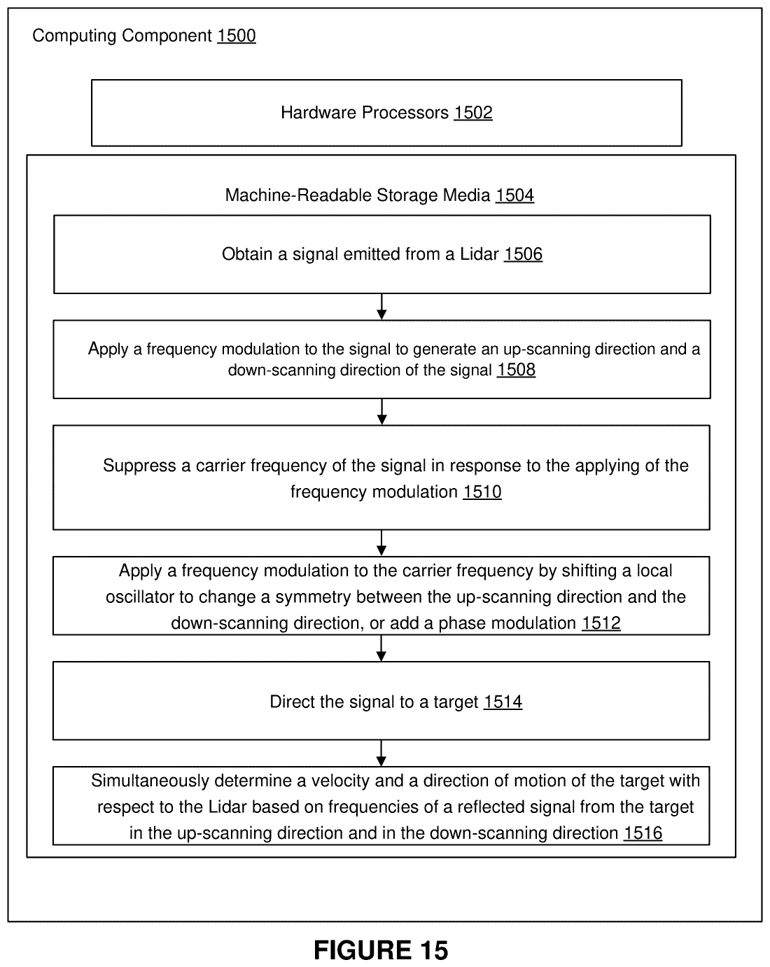

FIG. 15 illustrates a computing component 1500 that includes one or more hardware processors 1502 and machine-readable storage media 1504 storing a set of machine-readable/machine-executable instructions that, when executed, cause the hardware processor(s) 1502 to detect a heading direction of a target and navigate based on this detection, among other steps. It should be appreciated that there can be additional, fewer, or alternative steps performed in similar or alternative orders, or in parallel, within the scope of the various embodiments discussed herein unless otherwise stated. The computing component 1500 may be implemented as the computing system 352 of FIG. 3. The hardware processors 1502 may be implemented as the hardware processors 353 of FIG. 3. The machine-readable storage media 1504 may be implemented as the machine-readable storage media 362 of FIG. 3, and may include suitable machine-readable storage media described in FIG. 17.

At step 1506, the hardware processor(s) 1502 may execute machine-readable/machine-executable instructions stored in the machine-readable storage media 1504 to obtain a signal emitted from a Lidar (e.g., the Lidar 408 or 608 and/or incorporating the laser source 203), which may include a light signal. This signal will be processed in the subsequent steps.

In step 1508, the hardware processor(s) 1502 may execute machine-readable/machine-executable instructions stored in the machine-readable storage media 1504 to apply a frequency modulation to the signal to generate an up-scanning direction and a down-scanning direction of the signal. The up-scanning direction and the down-scanning direction are symmetric, meaning that magnitudes, or absolute values, of slopes in the up-scanning direction and the down-scanning direction are the same, but reversed in direction. The slopes may be indicative of respective rates of change of frequencies in the up-scanning direction and the down-scanning direction over time.

In step 1510, the hardware processor(s) 1502 may execute machine-readable/machine-executable instructions stored in the machine-readable storage media 1504 to suppress a carrier frequency of the signal in response to the applying of the frequency modulation. In step 1512, the hardware processor(s) 1502 may execute machine-readable/machine-executable instructions stored in the machine-readable storage media 1504 to either 1) apply a frequency modulation to the carrier frequency by shifting a local oscillator to change a symmetry between the up-scanning direction and the down-scanning direction, as illustrated in FIG. 3-4, or 2) add a phase modulation, as illustrated in FIGS. 5-7. A result of step 1512 is that magnitudes of the slopes in the up-scanning direction and the down-scanning direction will be different from each other, with the magnitude of the slope in the up-scanning direction being higher than the magnitude of the slope in the down-scanning direction.

In step 1514, the hardware processor(s) 1502 may execute machine-readable/machine-executable instructions stored in the machine-readable storage media 1504 to direct the signal to a target, for example, an obstacle. In step 1516, the hardware processor(s) 1502 may execute machine-readable/machine-executable instructions stored in the machine-readable storage media 1504 to Simultaneously determine a velocity and a direction of motion of the target with respect to the Lidar based on frequencies of a reflected signal from the target in the up-scanning direction and in the down-scanning direction 1516. This velocity and direction of motion, or heading direction, may be a basis to determine a navigation action, for example, of a vehicle, as illustrated in FIGS. 8-14.

### Hardware Implementation

The techniques described herein are implemented by one or more special-purpose computing devices. The special-purpose computing devices may be hard-wired to perform the techniques, or may include circuitry or digital electronic devices such as one or more application-specific integrated circuits (ASICs) or field programmable gate arrays (FPGAs) that are persistently programmed to perform the techniques, or may include one or more hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, server computer systems, portable computer systems, handheld devices, networking devices or any other device or combination of devices that incorporate hard-wired and/or program logic to implement the techniques.

Computing device(s) are generally controlled and coordinated by operating system software. Operating systems control and schedule computer processes for execution, perform memory management, provide file system, networking, I/O services, and provide a user interface functionality, such as a graphical user interface (“GUI”), among other things.

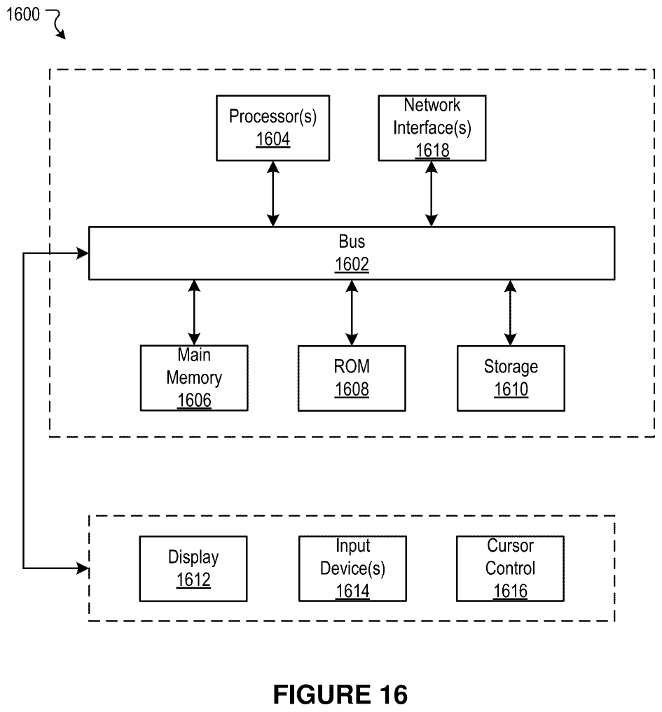

FIG. 16 is a block diagram that illustrates a computer system 1600 upon which any of the embodiments described herein may be implemented. In some examples, the computer system 1600 may include a cloud-based or remote computing system. For example, the computer system 1600 may include a cluster of machines orchestrated as a parallel processing infrastructure. The computer system 1600 includes a bus 1602 or other communication mechanism for communicating information, one or more hardware processors 1604 coupled with bus 1602 for processing information. Hardware processor(s) 1604 may be, for example, one or more general purpose microprocessors.

The computer system 1600 also includes a main memory 1606, such as a random access memory (RAM), cache and/or other dynamic storage devices, coupled to bus 1602 for storing information and instructions to be executed by processor 1604. Main memory 1606 also may be used for storing temporary variables or other intermediate information during execution of instructions to be executed by processor 1604. Such instructions, when stored in storage media accessible to processor 1604, render computer system 1600 into a special-purpose machine that is customized to perform the operations specified in the instructions.

The computer system 1600 further includes a read only memory (ROM) 1608 or other static storage device coupled to bus 1602 for storing static information and instructions for processor 1604. A storage device 1610, such as a magnetic disk, optical disk, or USB thumb drive (Flash drive), etc., is provided and coupled to bus 1602 for storing information and instructions.

The computer system 1600 may be coupled via bus 1602 to a display 1612, such as a cathode ray tube (CRT) or LCD display (or touch screen), for displaying information to a computer user. An input device 1614, including alphanumeric and other keys, is coupled to bus 1602 for communicating information and command selections to processor 1604. Another type of user input device is cursor control 1616, such as a mouse, a trackball, or cursor direction keys for communicating direction information and command selections to processor 1604 and for controlling cursor movement on display 1612. This input device typically has two degrees of freedom in two axes, a first axis (e.g., x) and a second axis (e.g., y), that allows the device to specify positions in a plane. In some embodiments, the same direction information and command selections as cursor control may be implemented via receiving touches on a touch screen without a cursor.

The computing system 1600 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “module,” as used herein, refers to logic embodied in hardware or firmware, or to a collection of software instructions, possibly having entry and exit points, written in a programming language, such as, for example, Java, C or C++. A software module may be compiled and linked into an executable program, installed in a dynamic link library, or may be written in an interpreted programming language such as, for example, BASIC, Perl, or Python. It will be appreciated that software modules may be callable from other modules or from themselves, and/or may be invoked in response to detected events or interrupts. Software modules configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware modules may be comprised of connected logic units, such as gates and flip-flops, and/or may be comprised of programmable units, such as programmable gate arrays or processors. The modules or computing device functionality described herein are preferably implemented as software modules, but may be represented in hardware or firmware. Generally, the modules described herein refer to logical modules that may be combined with other modules or divided into sub-modules despite their physical organization or storage.

The computer system 1600 may implement the techniques described herein using customized hard-wired logic, one or more ASICs or FPGAs, firmware and/or program logic which in combination with the computer system causes or programs computer system 1600 to be a special-purpose machine. According to one embodiment, the techniques herein are performed by computer system 1600 in response to processor(s) 1604 executing one or more sequences of one or more instructions contained in main memory 1606. Such instructions may be read into main memory 1606 from another storage medium, such as storage device 1610. Execution of the sequences of instructions contained in main memory 1606 causes processor(s) 1604 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1610. Volatile media includes dynamic memory, such as main memory 1606. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1602. Transmission media can also take the form of acoustic or light waves, such as those generated during radio-wave and infra-red data communications.

Various forms of media may be involved in carrying one or more sequences of one or more instructions to processor 1604 for execution. For example, the instructions may initially be carried on a magnetic disk or solid state drive of a remote computer. The remote computer can load the instructions into its dynamic memory and send the instructions over a telephone line using a modem. A modem local to computer system 1600 can receive the data on the telephone line and use an infra-red transmitter to convert the data to an infra-red signal. An infra-red detector can receive the data carried in the infra-red signal and appropriate circuitry can place the data on bus 1602. Bus 1602 carries the data to main memory 1606, from which processor 1604 retrieves and executes the instructions. The instructions received by main memory 1606 may retrieves and executes the instructions. The instructions received by main memory 1606 may optionally be stored on storage device 1610 either before or after execution by processor 1604.

The computer system 1600 also includes a communication interface 1618 coupled to bus 1602. Communication interface 1618 provides a two-way data communication coupling to one or more network links that are connected to one or more local networks. For example, communication interface 1618 may be an integrated services digital network (ISDN) card, cable modem, satellite modem, or a modem to provide a data communication connection to a corresponding type of telephone line. As another example, communication interface 1618 may be a local area network (LAN) card to provide a data communication connection to a compatible LAN (or WAN component to communicated with a WAN). Wireless links may also be implemented. In any such implementation, communication interface 1618 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through communication interface 1618, which carry the digital data to and from computer system 1600, are example forms of transmission media.

The computer system 1600 can send messages and receive data, including program code, through the network(s), network link and communication interface 1618. In the Internet example, a server might transmit a requested code for an application program through the Internet, the ISP, the local network and the communication interface 1618.

The received code may be executed by processor 1604 as it is received, and/or stored in storage device 1610, or other non-volatile storage for later execution.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

The various features and processes described above may be used independently of one another, or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be removed, executed out of order from that shown or discussed, including substantially concurrently or in reverse order, depending on the functionality involved, as would be understood by those skilled in the art.

It should be emphasized that many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

It will be appreciated that “logic,” a “system,” “data store,” and/or “database” may comprise software, hardware, firmware, and/or circuitry. In one example, one or more software programs comprising instructions capable of being executable by a processor may perform one or more of the functions of the data stores, databases, or systems described herein. In another example, circuitry may perform the same or similar functions. Alternative embodiments may comprise more, less, or functionally equivalent systems, data stores, or databases, and still be within the scope of present embodiments. For example, the functionality of the various systems, data stores, and/or databases may be combined or divided differently.

“Open source” software is defined herein to be source code that allows distribution as source code as well as compiled form, with a well-publicized and indexed means of obtaining the source, optionally with a license that allows modifications and derived works.

The data stores described herein may be any suitable structure (e.g., an active database, a relational database, a self-referential database, a table, a matrix, an array, a flat file, a documented-oriented storage system, a non-relational No-SQL system, and the like), and may be cloud-based or otherwise.

As used herein, the term “or” may be construed in either an inclusive or exclusive sense. Moreover, plural instances may be provided for resources, operations, or structures described herein as a single instance. Additionally, boundaries between various resources, operations, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Although the invention has been described in detail for the purpose of illustration based on what is currently considered to be the most practical and preferred implementations, it is to be understood that such detail is solely for that purpose and that the invention is not limited to the disclosed implementations, but, on the contrary, is intended to cover modifications and equivalent arrangements that are within the spirit and scope of the appended claims. For example, it is to be understood that the present invention contemplates that, to the extent possible, one or more features of any figure or example can be combined with one or more features of any other figure or example. A component being implemented as another component may be construed as the component being operated in a same or similar manner as the another component, and/or comprising same or similar features, characteristics, and parameters as the another component.

The phrases “at least one of,” “at least one selected from the group of,” or “at least one selected from the group consisting of,” and the like are to be interpreted in the disjunctive (e.g., not to be interpreted as at least one of A and at least one of B).

Reference throughout this specification to an “example” or “examples” means that a particular feature, structure or characteristic described in connection with the example is included in at least one example of the present invention. Thus, the appearances of the phrases “in one example” or “in some examples” in various places throughout this specification are not necessarily all referring to the same examples, but may be in some instances. Furthermore, the particular features, structures, or characteristics may be combined in any suitable manner in one or more different examples.

1. A system, comprising:
one or more processors; and
memory storing instructions that, when executed by the one or more processors, cause the system to perform:
obtaining a signal emitted from a Lidar;
applying a frequency modulation to the signal to generate an up-scanning direction and a down-scanning direction of the signal, wherein the up-scanning direction and the down-scanning direction are symmetric;
suppressing a carrier frequency of the signal in response to the applying of the frequency modulation;
in response to suppressing the carrier frequency, applying a frequency modulation to the carrier frequency by shifting a local oscillator to change a symmetry between the up-scanning direction and the down-scanning direction, or adding a phase modulation;
in response to applying the frequency modulation to the carrier frequency, directing the signal to a target; and
simultaneously determining a velocity and a direction of motion of the target with respect to the Lidar based on frequencies of a reflected signal from the target in the up-scanning direction and in the down-scanning direction.

2. The system of claim 1, wherein the up-scanning direction and the down-scanning direction have a same magnitude of slope, wherein the magnitude of slope indicates a rate of change of respective frequencies in the up-scanning direction and the down-scanning direction over time.

3. The system of claim 2, wherein the changing of the symmetry comprises shifting the local oscillator to increase a magnitude of the slope in the up-scanning direction and decreasing a magnitude of the slope in the down-scanning direction.

4. The system of claim 1, wherein the simultaneously determining of the velocity and the direction of motion is based on a difference between the frequencies of the reflected signal in the up-scanning direction and in the down-scanning direction.

5. The system of claim 1, further comprising a directly modulated laser to perform the modulating of the carrier frequency.

6. The system of claim 1, wherein the instructions cause the system to perform adding the phase modulation, the phase modulation comprising a phase modulation serrodyne frequency shift (PS-SFS).

7. The system of claim 1, wherein the simultaneously determining a velocity and a direction of motion of the target with respect to the Lidar is based on a modulation rate of sawtooth scanning.

8. The system of claim 1, wherein the simultaneously determining a velocity and a direction of motion of the target with respect to the Lidar is based on an offset by which a local oscillator of the Lidar is shifted.

9. The system of claim 1, wherein the instructions cause the system to perform navigating a vehicle based on the velocity and the direction of motion of the target.

10. The system of claim 1, wherein the velocity of the target is at most 300 kilometers per hour.

11. A computer-implemented method of a computing system, the computer-implemented method comprising:
obtaining a signal emitted from a Lidar;
applying a frequency modulation to the signal to generate an up-scanning direction and a down-scanning direction of the signal, wherein the up-scanning direction and the down-scanning direction are symmetric;
suppressing a carrier frequency of the signal in response to the applying of the frequency modulation;
in response to suppressing the carrier frequency, applying a frequency modulation to the carrier frequency by shifting a local oscillator to change a symmetry between the up-scanning direction and the down-scanning direction, or adding a phase modulation;
in response to applying the frequency modulation to the carrier frequency, directing the signal to a target; and
simultaneously determining a velocity and a direction of motion of the target with respect to the Lidar based on frequencies of a reflected signal from the target in the up-scanning direction and in the down-scanning direction.

12. The computer-implemented method of claim 11, wherein the up-scanning direction and the down-scanning direction have a same magnitude of slope, wherein the magnitude of slope indicates a rate of change of respective frequencies in the up-scanning direction and the down-scanning direction over time.

13. The computer-implemented method of claim 12, wherein the changing of the symmetry comprises shifting the local oscillator to increase a magnitude of the slope in the up-scanning direction and decreasing a magnitude of the slope in the down-scanning direction.

14. The computer-implemented method of claim 11, wherein the simultaneously determining of the velocity and the direction of motion is based on a difference between the frequencies of the reflected signal in the up-scanning direction and in the down-scanning direction.

15. The computer-implemented method of claim 11, wherein the performing of the modulating of the carrier frequency is by a directly modulated laser.

16. The computer-implemented method of claim 11, further comprising adding the phase modulation, the phase modulation comprising a phase modulation serrodyne frequency shift (PS-SFS).

17. The computer-implemented method of claim 11, wherein the simultaneously determining a velocity and a direction of motion of the target with respect to the Lidar is based on a modulation rate of sawtooth scanning.

18. The computer-implemented method of claim 11, wherein the simultaneously determining a velocity and a direction of motion of the target with respect to the Lidar is based on an offset by which a local oscillator of the Lidar is shifted.

19. The computer-implemented method of claim 11, further comprising navigating a vehicle based on the velocity and the direction of motion of the target.

20. The computer-implemented method of claim 11, wherein the velocity of the target is at most 300 kilometers per hour.
